(19) United States
(12) Patent Application Publication
(10) Pub. No.: US 2017/0268643 A1
(43) Pub. Date: Sep. 21, 2017

(54) FINGER-LESS END CAP RETURN FOR BALL SCREW ASSEMBLY

(71) Applicant: Dynatect Manufacturing, Inc., New Berlin, WI (US)

(72) Inventors: Thomas R. Burpee, Traverse City, MI (US); Scott Smith, Interlochen, MI (US); Christopher Bach, Kingsley, MI (US)

(73) Assignee: Dynatect Manufacturing, Inc., New Berlin, WI (US)

(21) Appl. No.: 15/461,165

(22) Filed: Mar. 16, 2017

Related U.S. Application Data
(60) Provisional application No. 62/309,277, filed on Mar. 16, 2016.

(51) Int. Cl. F16H 25/22

(52) U.S. Cl. CPC F16H 25/2219; F16H 2025/2481

(57) ABSTRACT

This invention relates to an end cap return for a ball screw. The end cap uses tangential force from the sidewalls of the ball passage to roll the ball bearings sideways out of the leadscrew raceway rather than the typical protruding finger that picks the balls up directly. The end cap allows it to be advantageously fabricated with using additive manufacturing, making the end cap cost effective for use in custom ball screw assemblies. In some embodiments, the end cap may include an insert for certain portions of the end cap that can be easily and inexpensively replaced should the insert become worn.

### CROSS-REFERENCE TO RELATED APPLICATION

This application is based on and claims priority to U.S. Provisional Patent Application No. 62/309,277 filed on Mar. 16, 2016, which is incorporated herein by reference in its entirety for all purposes.

### FIELD OF THE INVENTION

The present invention relates generally to the field of linear motion. More particularly, the present invention relates to ball return mechanisms in ball screw assemblies.

### BACKGROUND

A ball screw is a mechanical device that translates rotational motion into linear motion with minimal friction. Ball screws have high mechanical efficiency and are capable of being manufactured to very high tolerances, making them ideal for applications that require precision movements over a long lifetime.

Typical ball screws include a leadscrew portion that is threaded to include at least one raceway through which a series of ball bearings travel. Each raceway has a pitch, which is defined as the axial distance between threads and is typically measured in threads per inch or millimeter. Leadscrews may have one raceway, or may alternatively include multiple raceways that follow alongside each other. The ball bearings are captured inside a ball nut that includes its own raceways that correspond to the channels of the leadscrew. The ball bearings transfer the load between the ball nut and the leadscrew.

As the ball nut travels along the leadscrew, the ball bearings recirculate through the nut. As such, it is necessary to include a way for the balls to return from one end of the ball nut to the other. Typical ball return systems are either external, internal, or end cap. External ball return systems include a ball return tube outside the nut for each channel that carries the balls from one end of the channel to the other. Internal ball return systems operate very similarly to external ball return systems, except that the ball return component is located within the outer diameter of the nut. As the name suggests, end cap ball return systems include end caps, one on each end of the ball nut, that include channels to guide the balls into and out of a ball return tube formed in the ball nut.

All of the various ball return systems have their advantages and dis-advantages, but the simplest design is the end cap. In a ball nut fitted with end cap returns, the ball bearings enter one end of the nut as it travels down the screw and traverse the entire length of the nut before coming out the other end and getting picked-up by a plastic or metal cap placed on the end of the nut. After picking the ball bearings out of the ball raceway, the end cap redirects the balls into a return hole drilled longitudinally through the nut. The balls are then re-directed back into the screw raceway by a cap on the opposite end of the nut.

Current end cap designs typically employ a deflector, or “finger,” that extends into the raceway and lifts the balls out of the raceway before re-directing them into a return hole that is drilled through the nut. As the ball bearings roll through the passage leading to the finger, the finger lifts the balls out of their track in the screw and then re-directs the balls to the entrance of the return tube that is drilled through the nut. This finger is subjected to constant pounding as each ball crashes into it at high speed as it is lifted out of the ball track. Over time the finger will wear down until it eventually will not lift the balls from the ball track anymore and causes a total failure of the ball screw. Because of the need for high durability of the finger, it must be fabricated using expensive materials and processes.

As such, there is a need for an end cap design that is easy to manufacture in small quantities and is not subject to failure from repeated impacts to a finger.

### SUMMARY

The present invention relates to a ball screw assembly. The assembly includes a ball nut and a leadscrew. A plurality of ball bearings are secured between the ball nut and the leadscrew and circulate within the ball nut as the leadscrew rotates. The ball screw assembly includes a leadscrew having at least one leadscrew raceway, and a ball nut. The ball nut has a main body surrounding the leadscrew and at least one internal raceway that aligns with the leadscrew raceway, and two ends. Two end cap returns are removably attached to the ends of the ball nut. Each end cap return includes a semi-round, helical protrusion extending therefrom and filling at least a portion of the leadscrew raceway. Near the helical protrusion, each end cap return further includes a depression that removes the ball bearings from the leadscrew raceway using tangential force. Each end cap also includes a ball track to direct the ball bearings from the depression to an entrance of a longitudinal tube that passes through the ball nut and into the ball track of the end cap at the other end of the ball nut.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of a ball screw having one embodiment of fingerless end caps in accordance with the invention;

FIG. 2 is a perspective view of a prior art end cap for a ball screw;

FIG. 3 is a perspective view of one embodiment of a fingerless end cap for a ball screw in accordance with the invention;

FIG. 4 is an exploded perspective view of the fingerless end cap of FIG. 3 showing an insert removed from the end cap body;

FIG. 5 is another perspective view of the fingerless end cap of FIG. 3 showing the insert inserted into the end cap body;

FIG. 6 is a section view of the fingerless end cap of FIG. 3 taken generally along the line 6-6 in FIG. 5;

FIG. 7 is another section view of the fingerless end cap of FIG. 3 taken generally along the line 7-7 in FIG. 6;

FIG. 8 is a top view of the ball screw of FIG. 1;

FIG. 9 is another perspective view of the ball screw of FIG. 1 with one end cap shown in section generally along the line 9-9 in FIG. 8 to show the path of the ball bearings through the end cap; and

FIG. 10 is another perspective view of the ball screw of FIG. 1 with one end cap attached in section generally along the line 10-10 in FIG. 8 to show the path of the ball bearings through the end cap.

### DETAILED DESCRIPTION

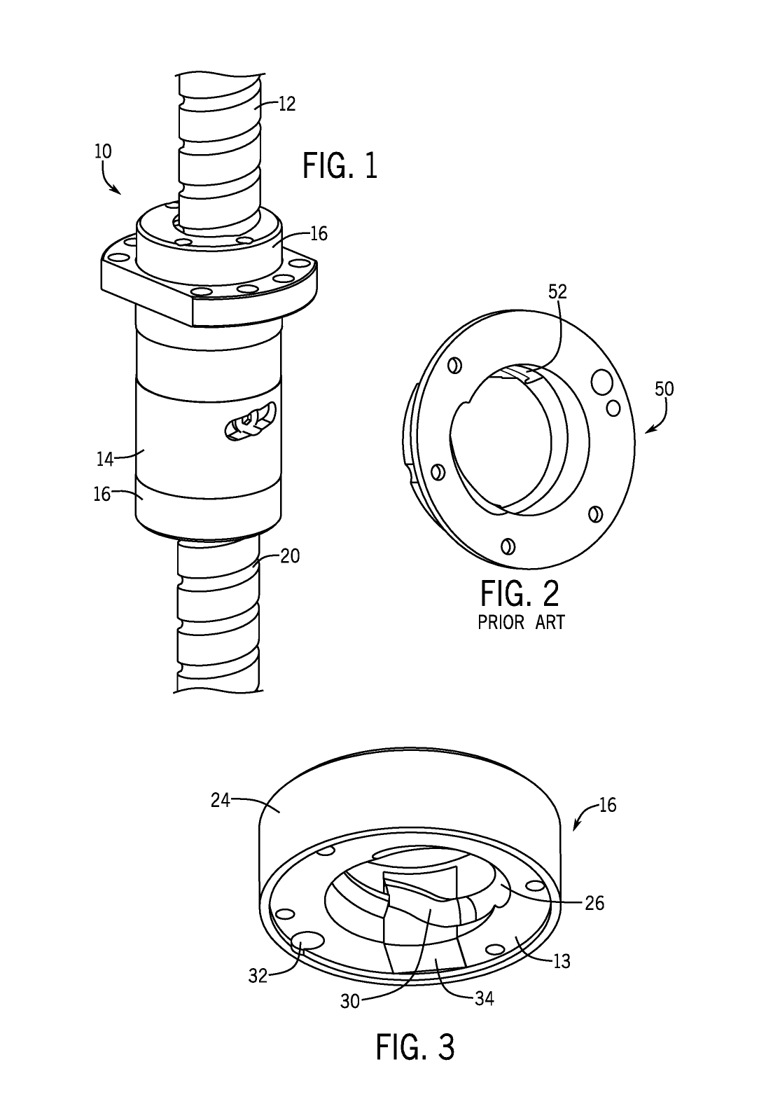

This invention relates to an end cap for a ball screw assembly that, through the geometry of a ball passage in the end cap, uses the tangential force of the sidewall of the ball passage in the end cap to roll the ball sideways out of the raceway in the screw. As shown in FIG. 1, ball screw assembly 10 includes a leadscrew 12, a ball nut 14, two end caps 16, and ball bearings 18 that roll in precision raceways 20 in the leadscrew (FIG. 9) and corresponding raceways in the ball nut. Rotating leadscrew 12 moves ball bearings 18 (the “balls”) along the raceways 20, thereby causing ball nut 14 to move longitudinally along the screw.

The end caps 16 on each end of ball nut 14 remove the balls 18 from raceway 20 and re-direct them through a longitudinal tube 22 that passes longitudinally through the nut to return them to the beginning of their path. In the embodiment shown, end caps 16 in the present embodiment are identical, but the present invention may be practiced with non-identical end caps. For example, it may be advantageous for only one end cap to include additional features to allow the ball nut to attach to or interact with another component. FIG. 2 shows one embodiment of a prior art end cap 50 that includes a finger 52 that redirect the balls 18 from the raceway 20 and ultimately into the longitudinal tube 22 through ball nut 14. The impact of the balls 18 on finger 52 causes the finger to wear down over time until it eventually will not lift the balls from the raceway 20.

End cap 16 is particularly suited for use with custom made, low volume manufacturing where leadscrews and nuts employ any desired combination of screw diameter, lead and ball size. Typical end caps must be made of extremely tough and durable plastic and must be either injection molded or cast before being finish machined. These processes require significant quantities to be produced in order to be cost effective making them impractical for use in low-volume ball screw applications. In contrast, because end cap 16 does not include a protrusion that experiences repeated impact loads, it may be made of much less durable material such as Ultem 9085 (polyetherimide), nylon, or may even be made by additive manufacturing, otherwise known as 3D printing.

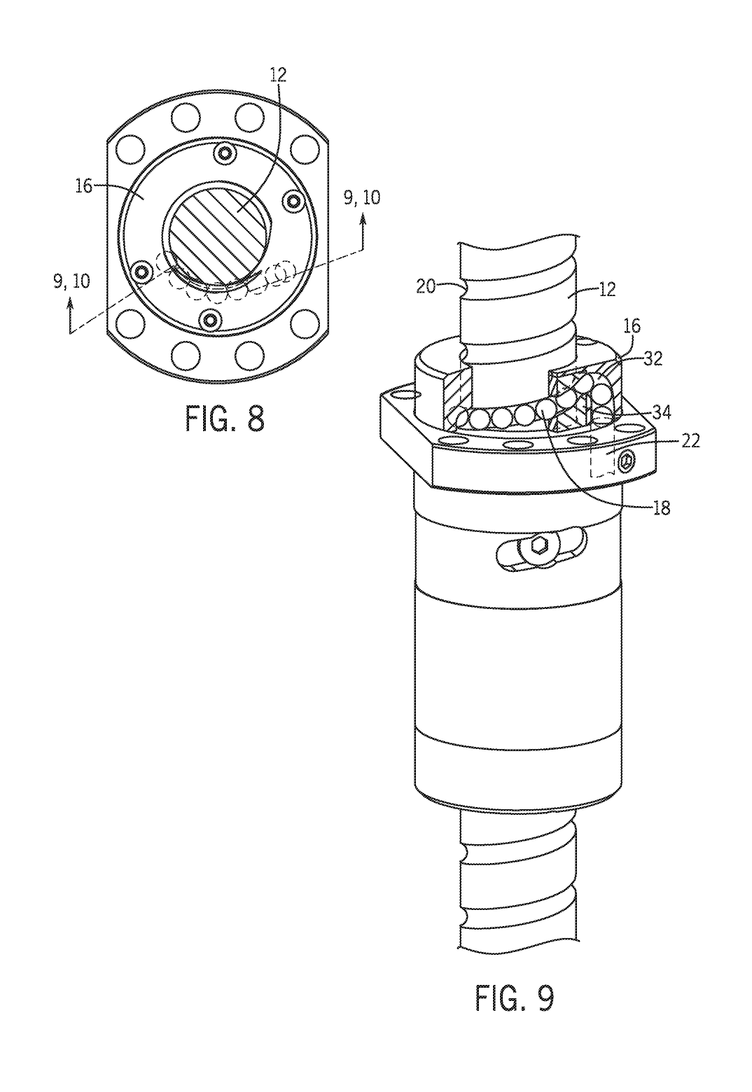

FIGS. 3-10 show one embodiment of a fingerless ball screw return end cap 16 in accordance with the invention. End cap 16 includes a main body 24 that surrounds the screw 12 and has a surface 13 that mates to the ball nut 14. In the embodiment shown, end cap 16 is removably attached to ball nut 14 by screws, but any other suitable fastening means may alternatively be used without departing from the invention. End cap 16 further includes insert 34 that, in the embodiment shown, is made of a more durable material than the rest of the end cap. A ball track 32 directs balls 18 through end cap 16 and back into ball nut 14.

Currently, the only known way to produce a substantially one piece end cap 16 is by additive manufacturing. The complex geometry of ball track 32 is blind and would be nearly impossible to machine and extremely difficult and cost ineffective to mold or cast. Additive manufacturing, on the other hand, easily creates ball track 32 and other complex geometry and is able to produce end caps for ball screws with endless combinations of screw diameter, lead and ball size without incurring any additional costs.

Ball track 32 includes a semi-round, helical protrusion 26 that extends from the end cap and fills the raceway 20 where the balls 18 are picked up or placed into the raceway. Adjacent helical protrusion 26, a depression 30 forms half of the raceway 20 where the balls 18 enter the end cap 16 from the ball nut 14. The depression 30 further eliminates sharp edges that would normally be subject to high wear and brittle fracture. Eliminating these sharp areas allows end cap 16 to be produced with using additive manufacturing and allows the end cap to be used in low-volume ball screw production.

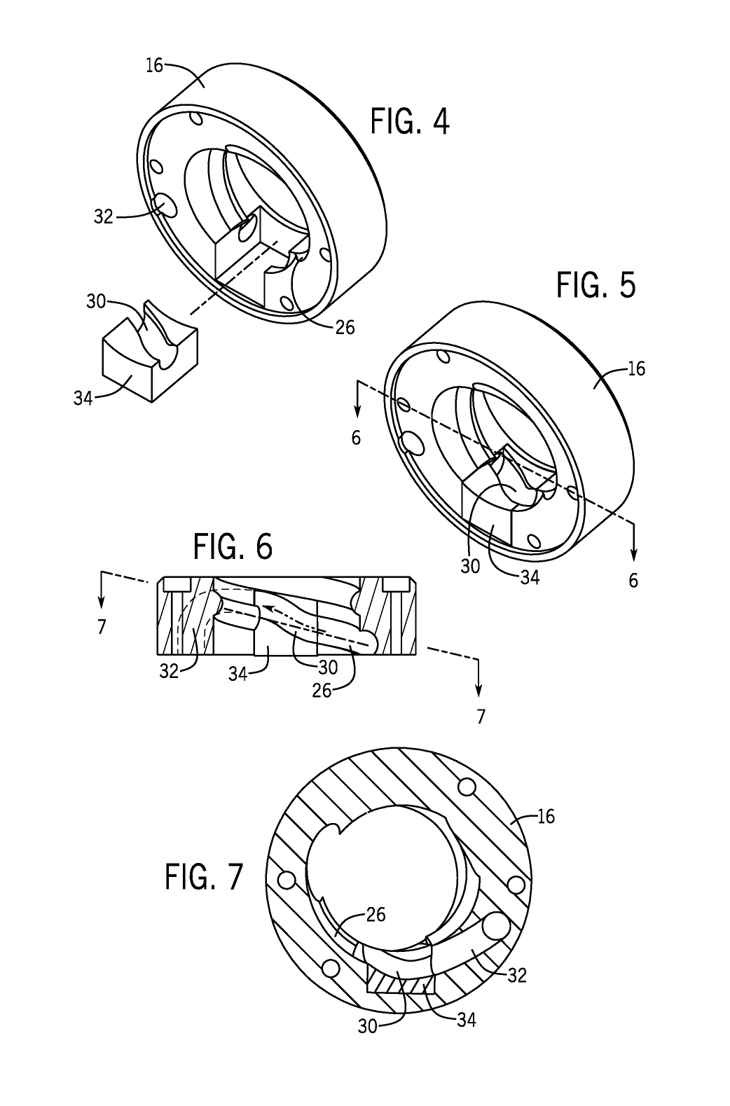

As shown in FIGS. 4-5, depression 30 may be included in an insert 34, which may be made of a more durable material than the 3D printed portion of end cap 16. In the embodiment shown, insert 34 is made of Nylatron GSM, but may be made of any suitable material without departing from the invention. Insert 34 is press-fit into end cap 16 and when the end cap is attached to ball nut 14, it is captured between leadscrew 12, the ball nut, and the end cap, making any additional fastening means unnecessary. Without the need to use additional fastening means, insert 34 may be easily and inexpensively replaced when it is worn.

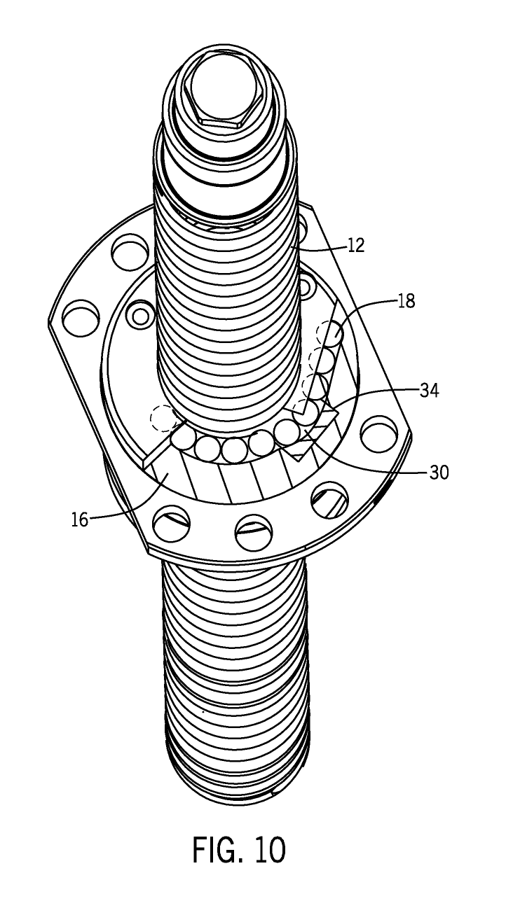

As shown in FIGS. 9-10, depression 30 removes the balls 18 from raceway 20 by permitting the balls to roll sideways out of the raceway. After passing through depression 30, balls 18 pass through ball track 32 which re-directs the balls to the longitudinal tube 22 in ball nut 14. The end cap 16 uses tangential force from the side walls of raceway 20 to roll the balls 18 sideways out of the raceway before reaching the portion of the end cap 16 that engages raceway 20 so minimal wear occurs to that part of the end cap. Even the part of the end cap 16 that directs the balls 18 into the end cap is not subjected to repeated impact forces, which increases the durability of the end cap when compared to existing end cap 50 that includes a finger 52 to remove balls 18 from raceway 20. Once the balls 18 enter the end cap 16, they are re-directed to the entrance of the longitudinal tube 22 through the ball nut 14 just as they are in a fingered design.

The end cap 16 opposite the direction of travel accepts the balls 18 from of the longitudinal tube 22 and directs them toward the direction of travel and provides a path for the balls back into raceway 20. In the embodiment shown, end caps 16 on either side of ball nut 14 are identical and perform either of the above functions when the direction of travel reverses.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A ball screw assembly comprising:
a leadscrew having at least one leadscrew raceway;
a ball nut having a main body surrounding the leadscrew; the ball nut including at least one internal raceway that aligns with the leadscrew raceway, and two ends;
two end cap returns removably attached to the ends of the ball nut;
a plurality of ball bearings recirculating through the ball nut as the leadscrew rotates, causing the ball nut to translate longitudinally along the lead screw;
the end cap returns including a semi-round, helical protrusion extending therefrom and filling at least a portion of the leadscrew raceway;
each end cap return further including a depression near the helical protrusion that remove the ball bearings from the leadscrew raceway using tangential force; and
each end cap return further including a ball track to direct the ball bearings from the depression to an entrance of a longitudinal tube that passes through the ball nut and into the ball track of the end cap at the other end of the ball nut.

2. The ball screw assembly of claim 1, wherein the depression is part of a removable insert made of a more durable material than the rest of the end cap returns.

3. The ball screw assembly of claim 1, wherein the end cap returns are produced using additive manufacturing.

4. The ball screw assembly of claim 1, wherein the depression is integrally formed into the end cap return.

5. The ball screw assembly of claim 1, wherein the end cap returns are removably attached to the ball nut by a plurality of screws.

6. The ball screw assembly of claim 2, wherein the removable insert is made of Nylatron GSM.

7. The ball screw assembly of claim 2, wherein the removable insert is made of plastic.

8. A ball screw assembly comprising:
a leadscrew having at least one leadscrew raceway;
a ball nut having a main body capable of surrounding the leadscrew, the ball nut including at least one internal raceway capable of being aligned with the leadscrew raceway, and two ends;
an end cap removably attached to one of the two ends of the ball nut;
a plurality of ball bearings for moving through the ball nut as the leadscrew rotates with respect to the ball nut, causing the ball nut to translate longitudinally along the lead screw;
the end cap including a semi-round, helical protrusion extending therefrom and capable of filling at least a portion of the leadscrew raceway; and
the end cap further including a depression adjacent the helical protrusion capable of removing the ball bearings from the leadscrew raceway by means of tangential force.

9. The ball screw assembly of claim 8 wherein the end cap includes a ball track to direct the ball bearings from the depression to an entrance of a ball return tube formed longitudinally in the ball nut.

10. The ball screw assembly of claim 9, wherein the depression is part of a removable insert made of a more durable material than the rest of the end cap.

11. The ball screw assembly of claim 8 wherein the end cap is produced using additive manufacturing.

12. The ball screw assembly of claim 8, wherein the depression is integrally formed into the end cap.

13. The ball screw assembly of claim 8, wherein the end cap is removably attached to the ball nut by a plurality of screws.

14. The ball screw assembly of claim 10, wherein the removable insert is made of Nylatron GSM.

15. The ball screw assembly of claim 10, wherein the removable insert is made of plastic.

16. A ball screw assembly comprising:
a leadscrew having at least one leadscrew raceway;
a ball nut having a main body capable of surrounding the leadscrew, the ball nut including at least one internal raceway capable of being aligned with the leadscrew raceway and carrying ball bearings therethrough, and two ends;
an end cap removably attached to one of the two ends of the ball nut;
the end cap including a semi-round, helical protrusion extending therefrom and capable of filling at least a portion of the leadscrew raceway; and
the end cap further including a depression adjacent the helical protrusion capable of removing the ball bearings from the leadscrew raceway by means of tangential force.

17. The ball screw assembly of claim 16, wherein the depression is part of a removable insert made of a more durable material than the rest of the end cap.

18. The ball screw assembly of claim 16, wherein the end cap is produced using additive manufacturing.

19. The ball screw assembly of claim 16, wherein the depression is integrally formed into the end cap.

20. The ball screw assembly of claim 16, wherein the end cap is removably attached to the ball nut by a plurality of screws.

21. The ball screw assembly of claim 16, wherein the ball screw assembly includes a plurality of ball bearings recirculating through the ball nut as the leadscrew rotates, causing the ball nut to translate longitudinally along the lead screw.

22. The ball screw assembly of claim 17, wherein the removable insert is made of Nylatron GSM.

23. The ball screw assembly of claim 17, wherein the removable insert is made of plastic.
